(19) United States
(12) Patent Application Publication
(10) Pub. No.: US 2009/0081498 A1
(43) Pub. Date: Mar. 26, 2009

(54) Catalyst reactor and fuel cell system comprising the same

(76) Inventors: Sung-jin Kim, Suwon-si (KR); Do-young Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/232,668

(22) Filed: Sep. 22, 2008

(30) Foreign Application Priority Data
Sep. 21, 2007 (KR) 10-2007-0096758

(51) Int. Cl. H01M 8/06

(52) U.S. Cl. 429/19; 422/218

(57) ABSTRACT

Disclosed is a catalyst reactor capable of effectively applying to a fuel cell system using a metal hydride solution as a fuel. The catalyst reactor includes a catalyst matrix including a micro-channel through which a hydrogen storage solution flows. The catalyst matrix has an open surface. The catalyst reactor also includes a gas/liquid separator covering the open surface of the catalyst matrix, and a catalyst formed on an inner surface of the micro-channel to extract hydrogen from the hydrogen storage solution.

### CLAIM OF PRIORITY

This application makes reference to, incorporates the same herein, and claims all benefits accruing under 35 U.S.C. §119 from an application earlier filed in the Korean Intellectual Property Office on the 21 Sep. 2007 and there duly assigned Serial No. 10-2007-0096758.

### BACKGROUND OF THE INVENTION

1. Field of the Invention

The present invention relates to a catalyst reactor of a fuel cell system, and more particularly to a catalyst reactor using a metal hydride solution, and a fuel cell system comprising the same.

2. Description of the Related Art

In general, a fuel cell is a generator system for directly converting chemical energy into electrical energy through the electrochemical reaction of hydrogen and oxygen. In the case of the hydrogen, pure hydrogen may be directly supplied to a fuel cell system, or hydrogen extracted from materials such as methanol, ethanol, natural gas, etc. may be supplied to a fuel cell system. In the case of the oxygen, pure oxygen may be directly supplied to a fuel cell system, or oxygen included in the air may be generally supplied to a fuel cell system using an air pump, etc.

The fuel cells are categorized into a polymer electrolyte fuel cell and a direct methanol fuel cell, a phosphoric acid fuel cell, a molten carbonate fuel cell, a solid oxide fuel cell, etc. Each of the fuel cells basically generates electricity in the same principle, but is different in the kinds of fuels used, the catalysts, the electrolytes, etc.

Among the fuel cells, the direct methanol fuel cell (DMFC) directly uses a liquid state of methanol as a fuel insead of a gaseous state of a hydrogen fuel. The direct methanol fuel cell has a lower output density than the fuel cells that directly use hydrogen as a fuel, but has a high energy density per volume of methanol used as the fuel, as well as the low-power and long-time operations due to the easy storage. Also, the direct methanol fuel cell (DMFC) may be desirably manufactured in a small scale since there is no need for additional devices such as a reformer for reforming a fuel to generate hydrogen.

Also, the direct methanol fuel cell includes an electrolyte membrane, and a membrane electrolyte assembly (MEA) composed of an anode electrode and a cathode electrode that are in contact with both sides of the electrolyte membrane. Fluorinated polymer and the like are used for the electrolyte membrane. Here, the fluorinated polymer has an advantage that a crossover phenomenon, in which unreacted methanol permeates electrolyte membrane, occurs due to the excellent permeability of methanol when a high concentration of methanol is used as a fuel. Accordingly, a fuel mixture in which water is mixed with methanol is supplied to a fuel cell system so as to reduce a concentration of methanol.

Meanwhile, the polymer electrolyte membrane fuel cell (PEMFC) uses hydrogen formed by reforming materials such as methanol, ethanol, natural gas, etc., and has highly excellent output characteristics, as well as a low operating temperature and rapid driving and response time, compared to the other fuel cells. Therefore, the polymer electrolyte membrane fuel cell is widely used in the applications of movable power source such as power source for automobiles, distributed power source for housing and public buildings, and transportable power source for portable electronic equipment.

Meanwhile, the polymer electrolyte membrane fuel cell functions to convert a raw material into a hydrogen-rich reformed gas through the catalytic reaction such as steam reforming (SR) and water gas shift (WGS), and also remove carbon monoxide that is included in the reformed gas and poisons catalysts in the fuel cell.

Since a configuration of the direct methanol fuel cell is simpler than the polymer electrolyte membrane fuel cell, the direct methanol fuel cell may be used in power supply equipment for a portable device. However, the direct methanol fuel cell has a problem that its portability deteriorates due to the use of a large amount of fuel since electric generator capacity is relatively low with respect to the amount of consumed fuel.

Recently, a metal hydride solution has been increasingly used as a hydrogen source for fuel cells. Metal hydride is an alloy that stores and discharges a large amount of hydrogen. The metal hydride solution is prepared by dissolving metal hydride in a predetermined solvent in order to improve convenience in its use. The development of fuel cells using the metal hydride solution is at the very beginning, but very promising for portable fuel cells due to the high hydrogen storage efficiency and easy handling.

In the case of the fuel cells using such a metal hydride solution, hydrogen stored in the metal hydride solution is separated by the catalytic reaction, but a sufficient amount of hydrogen should be separated to improve electric generation performance of the fuel cell, and an amount of the separated hydrogen should be able to be controlled.

However, the contemporary fuel cells using a metal hydride solution has problems that a total amount of generated hydrogen decreases if the fuel cell system is designed to be capable of easily controlling an amount of the separated hydrogen, while it is difficult to control an amount of the generated hydrogen if the fuel cell system is designed to increase an amount of the separated hydrogen.

### SUMMARY OF THE INVENTION

Accordingly, the present invention is designed to solve such drawbacks of the contemporary fuel cells, and therefore an object of the present invention is to provide a catalyst reactor capable of generating a sufficient amount of hydrogen from a hydrogen storage solution and a fuel cell system including the hydrogen generating device.

Also, another object of the present invention is to provide a catalyst reactor capable of easily controlling an amount of generated hydrogen from a hydrogen storage solution, and a fuel cell system including the hydrogen generating device.

One embodiment of the present invention is achieved by providing a catalyst reactor including a catalyst matric including a micro-channel through which a hydrogen storage solution flows where the catalyst matrix has an open surface, a gas/liquid separator covering the open surface of the micro-channel, and a catalyst formed in an inner surface of the micro-channel and extracting hydrogen from the hydrogen storage solution through a catalytic reaction. Hydrogen is discharged through the gas/liquid separator.

Another embodiment of the present invention is achieved by providing a fuel cell system that includes a fuel tank for storing a hydrogen storage solution, a catalyst reactor for receiving the hydrogen storage solution from the fuel tank to generate hydrogen, a fuel cell stack for generating electricity through the electrochemical reaction of hydrogen and oxygen, and a discharged fuel tank for keeping the hydrogen storage solution discharged from the hydrogen generating device. The fuel cell stack receives the-hydrogen from the hydrogen generating device. The catalyst reactor includes a catalyst matrix including a micro-channel through which the hydrogen storage solution flows where the micro-channel has an open surface, a gas/liquid separator covering the open surface of the micro-channel, and a catalyst formed in an inner surface of the micro-channel and extracting hydrogen from the hydrogen storage solution through a catalytic reaction. Hydrogen is discharged through the gas/liquid separator.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a structural diagram showing a configuration of a fuel cell system using a metal hydride solution for a fuel.

FIG. 2A is a cross-sectional view of a catalyst reactor according to one exemplary embodiment of the present invention.

FIG. 2B is a perspective view of the catalyst reactor according to one exemplary embodiment of the present invention.

FIG. 3 is a structural diagram showing a fuel cell system using a metal hydride solution as a fuel according to one exemplary embodiment of the present invention.

FIG. 4 is a structural diagram showing a fuel cell system using a metal hydride solution as a fuel according to another exemplary embodiment of the present invention.

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

For example, the term of fuel cell stack is used in the description of the present invention, but used for convenience in the use, and it is considered that the fuel cell stack used in the description of the present invention includes a stack composed of laminated unit cells, a stack composed of flat unit cells, and a single stack including a single unit cell.

In this exemplary embodiment, the sprite of the present invention applies to a fuel cell system using a metal hydride solution (hereinafter, abbreviated as a hydrogen storage solution) such as aqueous metal hydride solution as a fuel, and a fuel cell system using an NaBH₄ solution as a fuel will be described in detail as one example.

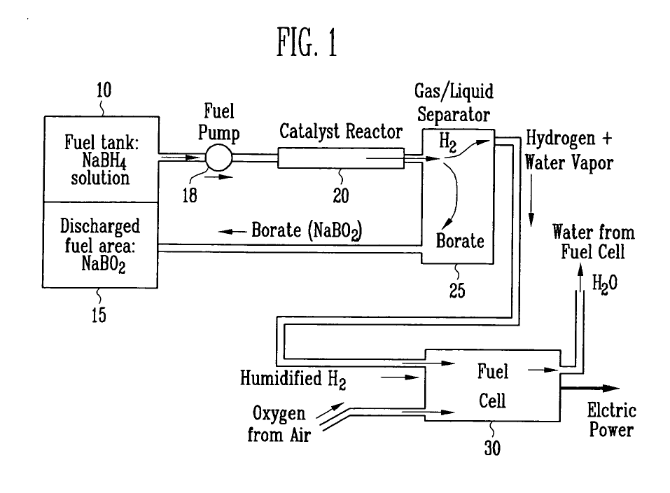

As shown in FIG. 1, the fuel cell system using an NaBH₄ solution as a fuel includes a fuel tank 10 for keeping an NaBH₄ solution used as a fuel, a fuel pump 18 for pumping an NaBH₄ solution from the fuel tank, a catalyst reactor 20 for generating hydrogen from the NaBH₄ solution through a catalytic reaction, a gas/liquid separator 25 for separating a hydrogen gas from a discharged fuel produced in the catalytic reaction, a stack 30 for generating electric power through the electrochemical reaction of oxygen and hydrogen generated in the catalyst reactor, and a discharge fuel tank 15 for storing a discharged fuel (NaBO₂) separated in the gas/liquid separator 25.

An inner part of the catalyst reactor 20 may be coated with catalyst particles such as Pt—LiCoO₂, and a chemical reaction represented by the following Equation 1 is carried in the catalyst reactor 20.

NaBH₄+2H₂O→NaBO₂+4H₄ Equation 1

The gas/liquid separator 25 has a structure in which a porous gas/liquid separator such as a membrane is used to separate a hydrogen gas from a discharged fuel solution. The general gas/liquid separators such as the conventional CO₂ gas/liquid separators may have a structure where a discharged fuel solution is collected in a lower portion of the gas/liquid separator and a hydrogen gas is collected in an upper portion of the gas/liquid separator.

The discharge fuel tank 15 functions to store an aqueous NaBO₂ solution that remains after the emission of hydrogen. The discharge fuel tank 15 further includes a pump formed in an input end thereof to improve a recovery efficiency of the aqueous NaBO₂ solution. In order to efficiently prevent waste of volumes, the discharge fuel tank 15 and the fuel tank 10 are preferably configured in a manner that the volumes of the fuel tank and the discharge fuel tank 15 are flexibly exchangeable each other.

The hydrogen separated in the gas/liquid separator 25 is humidified by mixing with vapor, and is then supplied to the stack 30. The stack 30 can be a polymer electrolyte membrane fuel cell that directly receives a hydrogen gas, and the stack 30 can be selected based on general conditions such as operation temperature.

The stack 30 generates electrical energy through the electrochemical reaction of the humidified hydrogen fuel supplied from the gas/liquid separator 25 and the oxygen supplied through an air supply unit (not shown). The stack 30 includes at least one unit of fuel cell that generates electrical energy. Also, the stack 30 may include a membrane electrode assembly for oxidizing/reducing the fuel and the oxygen, respectively, and a bipolar plate for supplying the hydrogen fuel and the oxygen to the membrane electrode assembly and for discharging products formed in the membrane electrode assembly. The membrane electrode assembly may have a structure in which an electrolyte membrane is disposed between an anode electrode and a cathode electrode, both of which are arranged in both sides of the membrane electrode assembly. The term of ‘stack’ refers to a unit fuel cell that has a single-layer or stacked-layer structure.

The fuel cell system using a NaBH₄ solution as a fuel has a reduced volume, compared to the polymer electrolyte membrane fuel cell, since it does not use a reformer having a big volume. Also, the fuel cell system using an NaBH₄ solution is desirable in aspect of the reduction in volume and the operation efficiency, since it does not need a complicated configuration, for example a recycler, in which a liquid fuel is circulated to be supplied into the stack. However, in the case of the catalyst reactor of the fuel cell system using the above-mentioned NaBH₄ solution, it is difficult to control an amount of the generated hydrogen while generating a sufficient amount of the hydrogen.

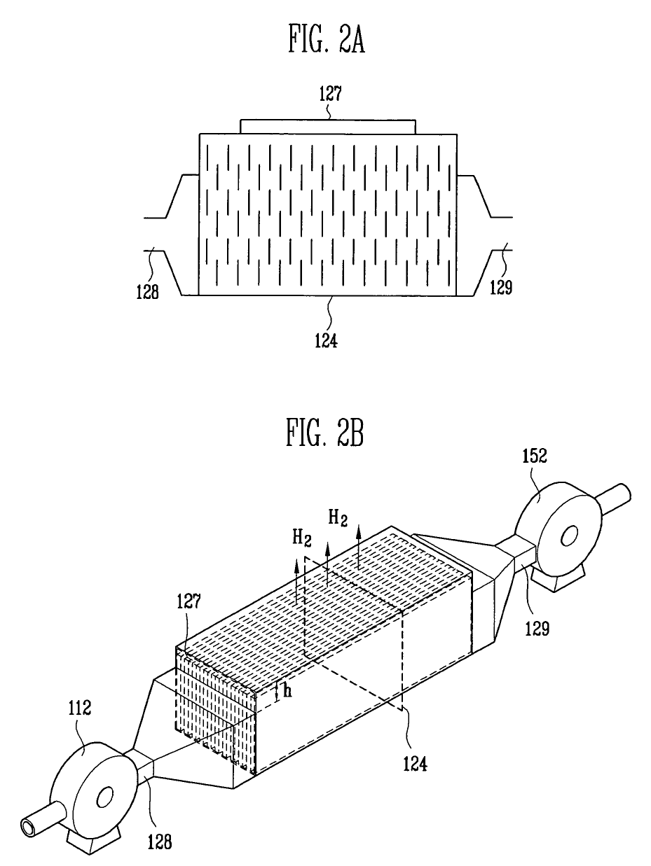

FIG. 2A is a cross-sectional view of a catalyst reactor according to one exemplary embodiment of the present invention. FIG. 2B shows a perspective view of the catalyst reactor constructed as one exemplary embodiment of the present invention. Referring to FIGS. 2A and 2B, the catalyst reactor includes a catalyst matrix 124, a gas/liquid separator 127, a fuel inlet 128, and a fuel outlet 129. The catalyst matrix 124 has macro-channels inside, and a hydrogen storage solution flows through the micro-channels of the catalyst matrix 124. The gas/liquid separator 127 covers the open surface of the catalyst matrix 124. The fuel inlet 128 supplies a hydrogen storage solution to the catalyst matrix 124. The fuel outlet 129 allows the hydrogen storage solution to flow out from the catalyst matrix 124 when the hydrogen separation reaction is over in the hydrogen storage solution. An inner surface (or wall) of the micro-channel is coated or impregnated with a catalyst such as Pt—LiCoO₂ for facilitating the separation of hydrogen from the hydrogen storage solution.

The micro-channel of the catalyst matrix 124 has a structure in which channels of slot shapes are provided in parallel. However, the micro-channel is not limited to the shapes as shown in the drawings, and other shapes can be used herein as long as the channels have a structure in which a contact area between an inner surface of a channel and a fluid flowing through the channel is maximized. For example, the micro-channel can be realized in shapes of a plurality of pin or slim pillars, or realized in shapes of slots through which a fluid flows in a zigzag or spiral direction.

The gas/liquid separator 127 prevents a fluid in the catalyst matrix 124 from flowing outward, and functions to allow a hydrogen gas generated in the hydrogen storage solution to flow out since it covers a top surface having an opening of the catalyst matrix 124. Here, the top surface refers to an absolute position with respect to the ground. As hydrogen gas is lighter than the hydrogen storage solution, the hydrogen tends to move upwards. Therefore, having the open surface at the top of the micro-channel makes it easy to collect the hydrogen gas.

As described above, the gas/liquid separator 127 is formed on the catalyst matrix 124, and functions to allow the hydrogen gas collected in an upper surface thereof due to the difference in density to easily flow out.

Also, the catalyst matrix 124 has an intermediate region that is higher than an inlet region and an outlet region by a height h as shown in FIG. 2B. This is a spare space (hereinafter, referred to as a hydrogen collecting region) in which a generated hydrogen gas may be collected from the hydrogen storage solution.

The fuel inlet 128 is a region for receiving a hydrogen storage solution from an external fuel tank. In FIG. 2B, it is shown that a sectional area of the fuel inlet 128 is smaller than a sectional area of the catalyst matrix 124, but the sectional area of the fuel inlet 128 can be substantially the same as a sectional area of a region in which a fluid flows through the catalyst matrix 124, which is the sectional area of the catalyst matrix except the sectional area for collecting the hydrogen gas as represented by height h in FIG. 2B.

The fuel outlet 129 is a region for supplying a discharged fuel of the hydrogen storage solution, which is fuel remaining after generation of hydrogen gas, to an external discharge fuel tank, the discharged. The sectional area of the fuel outlet 129 may be identical to the sectional area of the fuel inlet 128, as a volume of the hydrogen storage solution may not be dramatically changed by the removal of the hydrogen gas from the hydrogen storage solution.

A fuel pump 112, which may be coupled to the fuel inlet 128, and a recovery pump 152, which may be coupled to the fuel outlet 129, are shown in FIG. 2B. However, the fuel pump 112 and/or the recovery pump 152 may be configured as a part of the catalyst reactor 120.

Also, although not shown herein, the catalyst reactor may further include a frame for protecting the catalyst matrix 124 and supplying hydrogen gas, which flows through the gas/liquid separator 127, to an external fuel cell stack.

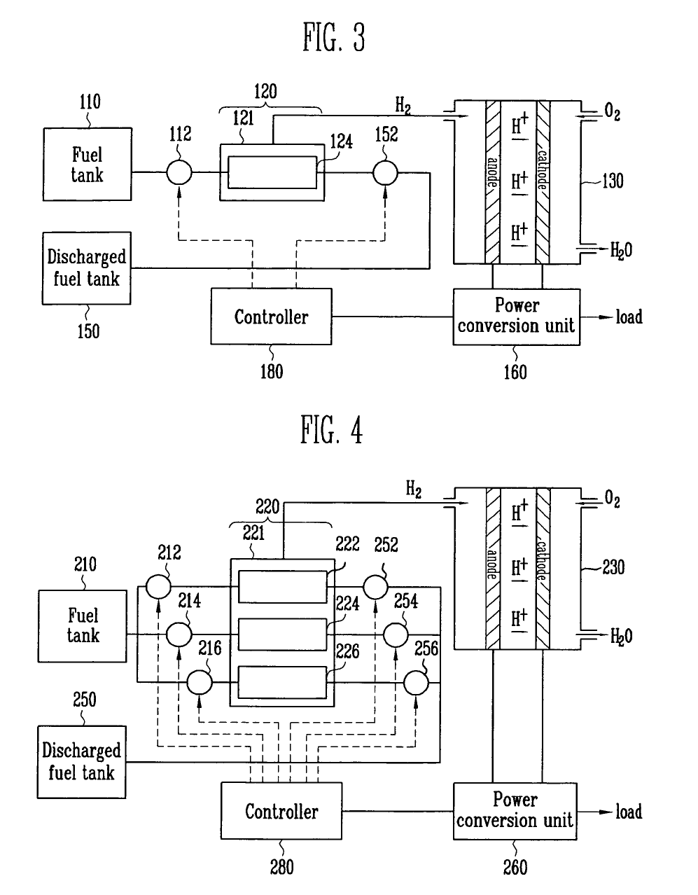

The frame is a region for accommodating the catalyst matrix 124 and for collecting hydrogen flowing from the gas/liquid separator 127. The frame has an opening for discharging hydrogen so that the hydrogen collected in the hydrogen collecting region can be supplied to the external fuel cell stack. The frame may be realized so that one catalyst matrix can be included in the frame (see FIG. 3), or may be realized so that a plurality of catalyst matrices can be included in the frame (see FIG. 4).

Also, although not shown herein, the catalyst reactor may further include a temperature maintenance unit for maintaining an operation temperature of the catalyst matrix 124 at an activation temperature of a catalyst that is present in the micro-channels of the catalyst matrix 124. The temperature maintenance unit may includes a heater or a cooling system that is operated by an electric power generated in the fuel cell stack or an electric power charged in an external secondary battery, considering that the hydrogen storage solution is used as the fuel.

FIG. 3 shows a fuel cell system according to one exemplary embodiment of the present invention. Referring to FIG. 3, the fuel cell system uses a catalyst reactor 120 to separate hydrogen from the hydrogen storage solution, the catalyst reactor 120 including one catalyst matrix.

As shown in FIG. 3, the fuel cell system includes a fuel tank 110 for keeping a hydrogen storage solution used as a fuel; a fuel cell stack 130 for generating electricity through the electrochemical reaction of hydrogen and oxygen; a catalyst reactor 120 having a configuration as shown in FIGS. 2A and 2B and separating hydrogen from the. hydrogen storage solution through the catalytic reaction; a discharge fuel tank 150 for keeping a discharged fuel of the hydrogen storage solution from which the hydrogen is separated; a fuel pump 112 for supplying a hydrogen storage solution in the fuel tank to the catalyst reactor 120; and a recovery pump 152 for supplying a discharged fuel of the hydrogen storage solution in the catalyst reactor 120 to the discharged fuel tank.

Also, the fuel cell system further includes an electric power conversion unit 160 for converting an electric power generated in the fuel cell stack 130 and supplying the converted electric power into an external load; and a controller 180 for controlling operations of the fuel pump 112 and/or the recovery pump 152 according to states of the electric generation in the fuel cell system.

Regarding the flow of the hydrogen storage solution in the fuel cell system as configured thus, the fuel stored in the fuel tank 110 flows through the micro-channels of the catalyst matrix 124 of the catalyst reactor 120 through the fuel pump 112. At this time, the hydrogen is separated from the hydrogen storage solution through the reaction with a catalyst arranged in walls of the micro-channels. The separated hydrogen flows through the gas/liquid separator, is collected in an inner space of the frame 121 of the catalyst reactor 120, and then is supplied to the anode electrode of the fuel cell stack 130 through a passage that connects the catalyst reactor to the fuel cell stack 130. The frame has an opening through which the collected hydrogen is dischated to the passage.

The discharged fuel of the hydrogen storage solution from which the hydrogen is separated in the micro-channels is recovered in the discharge fuel tank 150 through the recovery pump 152.

The controller 180 may be a hardware and/or software modules of a controller operated by power supplied from the electric power conversion unit 160 or a secondary battery (not shown) to control the entire operation of the fuel cell system, and to control an amount of generated hydrogen in the catalyst reactor 120 by controlling operations of the fuel pump 112 and the recovery pump 152.

The fuel pump 112 and the recovery pump 152 may be a pump, which can be easily controlled, such as a diaphragm pump or a pump using a stepping motor. In this case, the fuel cell system may determine quantity of an influx of the hydrogen storage solution fuel into the catalyst reactor 120, and an amount of the recovered discharged fuel by counting waveforms of a drive signal applied to the fuel pump 112 and the recovery pump 152. Also, the fuel cell system may control a pumping capacity by controlling the transition number or the duration time of the drive signal.

The controller 180 according to this exemplary embodiment may control an amount of the generated hydrogen by controlling driving of the fuel pump 112 and the recovery pump 152 using a variety of the methods.

As one method, the controller 180 operates the fuel pump 112 to supply a fuel as much as a capacity of the micro-channel 124 except for a hydrogen collecting region in the catalyst reactor 120 while the recovery pump 152 is stopped. The controller 180 operates the recovery pump to recover by-products in the catalyst reactor as much as an influx quantity of a fuel when the hydrogen is sufficiently separated by the catalyst impregnated in the micro-channel.

In the case of the above-mentioned control method, the hydrogen may be sufficiently separated from the hydrogen storage solution, but the electric generation in the fuel cell stack 130 is unstable since an amount of the generated hydrogen fluctuates with time.

As another method, the controller 180 may be configured so that it can operate the fuel pump 112 and the recovery pump 152 at a constant ratio to allow the hydrogen storage solution in the micro-channel to flow at a constant rate. In this method, the electric generation in the fuel cell stack 130 may be stabilized since the hydrogen is generated at a constant rate in the catalyst reactor 120. Also in this method, when it is required that an electric generator capacity of the fuel cell stack 130 should be increased due to the increase in loading capacity, the amount of the generated hydrogen may be easily controlled. For example, an amount of the generated hydrogen can be increased by increasing a flow rate of the hydrogen storage solution in the micro-channel. Meanwhile, if the flow rate of the hydrogen storage solution in the micro-channel increases, the hydrogen may not be sufficiently separated from the hydrogen storage solution. At this time, the micro-channel may be realized so that a flow length can be formed in a long and zigzag slot shape in order to easily control the amount of the generated hydrogen.

Also, the controller 180 may maintain an activation temperature of a catalyst to a suitable temperature using a temperature maintenance unit (not shown) for heating or cooling the catalyst matrix 124, depending on the sensing value of a temperature sensor (not shown) provided in the micro-channel of the catalyst reactor 120, the catalyst being present in a surface of the catalyst matrix 124.

FIG. 4 shows a fuel cell system according to another exemplary embodiment of the present invention. Referring to FIG. 4, the fuel cell system uses a catalyst reactor includes three catalyst matrices 222, 224 and 226 that can control the inner flows of the hydrogen storage solution, respectively, to separate hydrogen from the hydrogen storage solution.

The controller 280 may control an amount of generated hydrogen in the catalyst reactor 220 by controlling three fuel pumps 212, 214 and 216 and three recovery pumps 252, 254 and 256 to control the number of the micro-channels through which the hydrogen storage solution flows.

Descriptions of other components in the fuel cell system as shown in FIG. 4 are omitted since they may be deduced from the descriptions of the components as shown in FIG. 3.

The catalyst reactor according to the exemplary embodiments of the present invention may be useful to generate a sufficient amount of hydrogen from the hydrogen storage solution.

Also, the catalyst reactor according to the exemplary embodiments of the present invention may be useful to easily control an amount of the generated hydrogen from the hydrogen storage solution in the fuel cell system.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A catalyst reactor that generates hydrogen, comprising:
a catalyst matrix including a micro-channel through which a hydrogen storage solution flows, the catalyst matrix having an open surface;
a gas/liquid separator covering the open surface of the catalyst matrix, hydrogen discharged through the gas/liquid separator; and
a catalyst formed in an inner surface of the micro-channel and extracting hydrogen from the hydrogen storage solution through a catalytic reaction.

2. The catalyst reactor according to claim 1, further comprising:
an inlet through which the hydrogen storage solution flows into the micro-channel; and
an outlet through which the hydrogen storage solution flows out of the micro-channel.

3. The catalyst reactor according to claim 1, further comprising a frame accommodating the catalyst matrix and having a space for collecting hydrogen discharged from the gas/liquid separator.

4. The catalyst reactor according to claim 3, wherein the frame has an opening through which the collected hydrogen is discharged.

5. The catalyst reactor according to claim 1, wherein the open surface of the catalyst matrix is disposed in a top surface with respect to the ground.

6. The catalyst reactor according to claim 1, wherein the micro-channel is formed to have a plurality of parallel slots.

7. The catalyst reactor according to claim 1, wherein the micro-channel is formed in a zigzag slot shape.

8. The catalyst reactor according to claim 1, further comprising a temperature maintenance unit for maintaining the micro-channel at an activation temperature of the catalyst.

9. A fuel cell system, comprising:
a fuel tank for storing a hydrogen storage solution;
a catalyst reactor for receiving the hydrogen storage solution from the fuel tank to generate hydrogen, the catalyst reactor comprising:
a catalyst matrix including a micro-channel through which a hydrogen storage solution flows, the catalyst matrix having an open surface;
a gas/liquid separator covering the open surface of the catalyst matrix, hydrogen discharged through the gas/liquid separator; and
a catalyst formed in an inner surface of the micro-channel and extracting hydrogen from the hydrogen storage solution through a catalytic reaction;
a fuel cell stack for generating electricity through the electrochemical reaction of hydrogen and oxygen, the fuel cell stack receiving the hydrogen from the catalyst reactor; and
a discharge fuel tank for containing the hydrogen storage solution discharged from the catalyst reactor.

10. The fuel cell system according to claim 9, further comprising a fuel pump for supplying a hydrogen storage solution in the fuel tank to the catalyst reactor.

11. The fuel cell system according to claim 10, further comprising a recovery pump for supplying the hydrogen storage solution discharged from the catalyst reactor to the discharge fuel tank.

12. The fuel cell system according to claim 11, further comprising a controller for controlling operations of the fuel pump and the recovery pump according to an amount of electricity generated in the fuel cell stack.

13. The fuel cell system according to claim 12, wherein the controller operates the fuel pump to supply a fuel as much as a capacity of the micro-channel except for a hydrogen collecting space in the catalyst reactor while the recovery pump is stopped, and operates the recovery pump to recover by-products in the catalyst reactor as much as an influx quantity of a fuel when the hydrogen is sufficiently separated by the catalyst impregnated in the micro-channel.

14. The fuel cell system according to claim 12, wherein the controller operates the fuel pump and the recovery pump at the same ratio so that the hydrogen storage solution in the micro-channel flows at a constant rate.

15. The fuel cell system according to claim 9, wherein the catalyst reactor comprises at least two catalyst matrices for controlling the inner flows of the hydrogen storage solution.
